(19) United States
(12) Patent Application Publication
(10) Pub. No.: US 2017/0350561 A1
(43) Pub. Date: Dec. 7, 2017

(54) LEAK DETECTION BACKBONE AND FLOW BARRIERS

(71) Applicant: C-FER Technologies (1999) Inc., Edmonton (CA)

(72) Inventors: Brian Timothy WAGG, Edmonton (CA); Stephane Eric BUSSIERE, Edmonton (CA); Christopher Paul APPS, Edmonton (CA)

(21) Appl. No.: 15/612,453

(22) Filed: Jun. 2, 2017

Related U.S. Application Data
(60) Provisional application No. 62/344,804, filed on Jun. 2, 2016.

(51) Int. Cl. F17D 5/06; G01M 3/04; F16L 55/00

(52) U.S. Cl. CPC F17D 5/06; F16L 55/00; G01M 3/04

(57) ABSTRACT

A system and method of detecting a disturbance of a buried structure, for example an intrusion or a leak from a pipeline. Sensing devices at discrete locations connect with a backbone cable extending along a length of the pipeline. In the event of a leak, the signal from a sensing device is received at an output, via the backbone cable, providing notification of the leak and the location of the leak.

### CROSS REFERENCE TO RELATED APPLICATIONS

This application claims the benefit of priority of U.S. Provisional Patent Application No. 62/344,804 filed Jun. 2, 2016, which is hereby incorporated by reference.

### FIELD

The present disclosure relates generally to monitoring of a buried structure for leaks or intrusions. More particularly, the present disclosure relates to monitoring of buried pipelines for leaks or intrusions.

### BACKGROUND

Pipelines are used to transport a wide variety of materials in a generally safe and efficient manner. However, pipelines are subject to leaks or intrusions including, for example, incursions by unauthorized personnel, theft of equipment, materials or products, or ground movement. Intrusions may increase the risk of a leakage occurrence, cause damage, and/or impact pipeline safety.

Leaks from pipelines carrying liquid hydrocarbons or intrusions on pipeline right of ways are difficult to detect.

Several cable-based external leak detection technologies are sold commercially but it is difficult to detect leaks with most of these systems since the leaked material typically must contact the sensing cable, in some cases over a considerable length, to generate a sufficient signal to be detected. In addition, because the sensing cable must be installed very close to the pipeline, it is difficult to install such external leak detection cables along existing pipelines without significant risk of damaging the pipeline.

In addition, for small liquid leaks from buried pipelines, the liquid has been found to spread along the length of a pipeline through the relatively high permeability material around and below the pipe. This preferred (e.g. least resistance) flow path of the leaked fluid along the pipeline could delay the liquid from contacting cable-based leak detection systems buried some distance from the pipe and could lead to leaked fluid travelling considerable distances along the pipeline, making it difficult to determine the location of the leak origin and increasing the potential to contaminate a larger area along the pipeline.

It is, therefore, desirable to provide an improved underground leak detection system and method.

### SUMMARY

The disclosed system and method may be used to monitor intrusions, detect leaks, or other conditions that are of concern on a pipeline or other buried structure.

The system includes a backbone cable that is generally installed proximate to the buried structure that is being monitored. A plurality of branch cables are connected to the backbone cable and run from the backbone cable to the buried structure being monitored. The branch cables may be sensing devices or connect to one or more sensing devices installed in, on or near the buried structure to detect a leak of a leaked fluid by one of a variety of physical, chemical or other change in the environment. The backbone cable may also be a sensing device itself such as a fibre optic cable for distributed temperature or distributed acoustic sensing.

For installations where the monitoring system is intended to detect liquid leaks from buried structures such as pipelines, one or more flow barriers or dams, can be installed on or around the buried structure that inhibit the flow of liquids along the length of the buried structure through the surrounding soil. The flow barriers may include one or more sensors to indicate when specific fluids or gases come into contact with the flow barrier, indicating a leak from the buried structure. The flow barriers may also include means such as channels, wicks or conduits by which fluids that contact the flow barrier are directed to one or more points on the flow barrier where a sensing device detects the fluid. Further, the directing of the fluids towards the sensing device(s) may include guiding the fluid or conveying the fluid through physical or chemical means or a combination thereof. The sensing device(s) may be connected to the backbone cable by way of the branch cables.

It is an object of the present disclosure to obviate or mitigate at least one disadvantage of previous underground leak detection systems. It is an object of the invention to facilitate earlier and more reliable leak detection.

In a first aspect, the present disclosure provides a method for detecting a disturbance of a buried structure, including placing a backbone cable proximate to the buried structure, the backbone cable having a plurality of branch cable junctions, and sensing the disturbance at one or more sensing devices, the sensing devices connecting with the backbone cable.

In an embodiment disclosed, the method further includes indicating the disturbance to an operator or a control system to take a disturbance response action.

In an embodiment disclosed, the disturbance includes a ground incursion.

In an embodiment disclosed, the buried structure contains a fluid and the disturbance includes a leak of a leaked fluid.

In an embodiment disclosed, the buried structure includes at least a portion of a pipeline.

In an embodiment disclosed, the method further includes providing one or more flow barriers around an outer perimeter of the pipeline at discrete locations along the pipeline, wherein the flow barriers are adapted to restrict or prohibit flow or movement of the leaked fluid along the pipeline, direct the leaked fluid towards one or more sensing devices located within or near at least one of the one or more flow barriers, or combinations thereof.

In a further aspect, the present disclosure provides a monitoring system for detecting a disturbance of a buried structure, including a backbone cable, adapted to extend along a length of the buried structure, the backbone cable having a plurality of branch cable junctions; one or more sensing devices, placed along the backbone cable, and connected with the backbone cable via the branch cable junctions, at least one of the one or more sensing devices adapted to sense the disturbance; and an output for indicating the disturbance.

In an embodiment disclosed, the output further includes a location identifier to indicate a location or an identifier or both of the at least one of the one or more sensing devices.

In an embodiment disclosed, the one or more sensing devices are selected from the group consisting of fibre optics, reactive polymer sensors, vapour sensing tubes, hydrocarbon sensing tubes, optical sensors, or similar devices, or combinations thereof.

In an embodiment disclosed, the disturbance includes a ground incursion.

In an embodiment disclosed, the buried structure contains a fluid and the disturbance includes a leak of a leaked fluid.

In an embodiment disclosed, the buried structure includes at least a portion of a pipeline.

In an embodiment disclosed, the monitoring system further includes one or more flow barriers around an outer perimeter of the pipeline at discrete locations along the pipeline, wherein the flow barriers are adapted to restrict or prohibit flow or movement of the leaked fluid along the pipeline, direct the leaked fluid towards one or more sensing devices located within or near at least one of the one or more flow barriers, or combinations thereof.

In an embodiment disclosed, the one or more flow barriers are adapted to direct the leaked fluid towards the at least one of the one or more sensing devices.

In an embodiment disclosed, the at least one of the one or more sensing devices is located within or proximate to at least one of the one or more flow barriers.

In an embodiment disclosed, the one or more flow barriers include a surface configuration adapted to direct the leaked fluid towards the at least one of the one or more sensing devices.

In an embodiment disclosed, the surface configuration of the flow barrier is selected from the group consisting of a least one trough, at least one groove, a wick, at least one capillary tube, or combinations thereof.

In an embodiment disclosed, the buried structure includes at least a portion of a plurality of pipelines in a right-of-way or utility corridor.

In an embodiment disclosed, one or more unused branch cable junctions are provided to allow for additional sensing devices to be subsequently added.

In an embodiment disclosed, the one or more flow barriers comprise a plurality of flow barriers, set at intervals of between about 1 metre and up to about several kilometres between successive flow barriers.

In a further aspect, the present disclosure provides an apparatus for restricting or directing the flow of a leaked fluid from a pipeline, including a flow barrier adapted to be placed around an outer perimeter of the pipeline.

In an embodiment disclosed, the flow barrier is adapted to be placed in close proximity or affixed to the pipeline.

In an embodiment disclosed, the flow barrier is made of a single element.

In an embodiment disclosed, the flow barrier includes a plurality of elements that overlap, interlock or are otherwise joined to form the flow barrier.

In an embodiment disclosed, the flow barrier comprises a compliant, fluid impermeable membrane.

In an embodiment disclosed, the apparatus further includes stiffening or strengthening structures to support the impermeable membrane.

In an embodiment disclosed, the flow barrier comprises one or more tubes or pockets, adapted to be inflated or filled with a filler material to conform the flow barrier to the pipeline or to surrounding soil or both.

In an embodiment disclosed, the flow barrier is substantially cylindrical or toroidal in shape.

In an embodiment disclosed, the flow barrier includes a plurality of hinged components, adapted to encircle the pipeline.

In an embodiment disclosed, the apparatus further includes one or more sensing devices within or proximate to the flow barrier, at least one of the one or more sensing devices adapted to detect the leaked fluid.

In an embodiment disclosed, the one or more sensing devices are selected from the group consisting of fibre optics, reactive polymer sensors, vapour sensing tubes, hydrocarbon sensing tubes, optical sensors, or other similar devices.

In an embodiment disclosed, the flow barrier includes a surface configuration adapted to direct the leaked fluid towards at least one of the one or more sensing devices.

In an embodiment disclosed, the surface configuration of the flow barrier is selected from the group consisting of a least one trough, at least one groove, a wick, at least one capillary tube.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 illustrates a monitoring system of the present disclosure, installed on a pipeline;

FIGS. 2A-2D depict an example installation sequence for a flow barrier of the present disclosure, composed of separate elements;

FIGS. 3A-3B depict an example installation sequence for a flow barrier of the present disclosure, composed of an assembly of elements;

FIGS. 4A-4B depict an example installation sequence for a flow barrier of the present disclosure, composed of a flexible element;

FIGS. 5A-5B depict an example installation sequence for a flow barrier of the present disclosure, composed of a flexible element with stiffening members;

FIGS. 6A-6B depict an example installation sequence for a flow barrier of the present disclosure, with cement injected to expand the barrier, to conform the flow barrier to the pipeline and the surrounding soil;

FIGS. 7A-7B depict exemplary embodiments of a flow barrier of the present disclosure, composed of hinged components;

FIGS. 8A-8B depict an example installation of a flow barrier of the present disclosure in a trench formed by hydrovac excavation;

FIGS. 9A-9C depict an example of a flow barrier of the present disclosure with corrugations or channels to direct fluid to a target region wherein a sensing device may be placed at or proximate to the target region;

FIG. 10 depicts an example of a flow barrier of the present disclosure having a composite construction; and

FIG. 11 is an example of a flow barrier of the present disclosure adapted to direct or channel leaked liquid towards one or more sensing devices located within or near a flow barrier.

### DETAILED DESCRIPTION

Generally, the present disclosure provides a method and system for monitoring buried structures for disturbances.

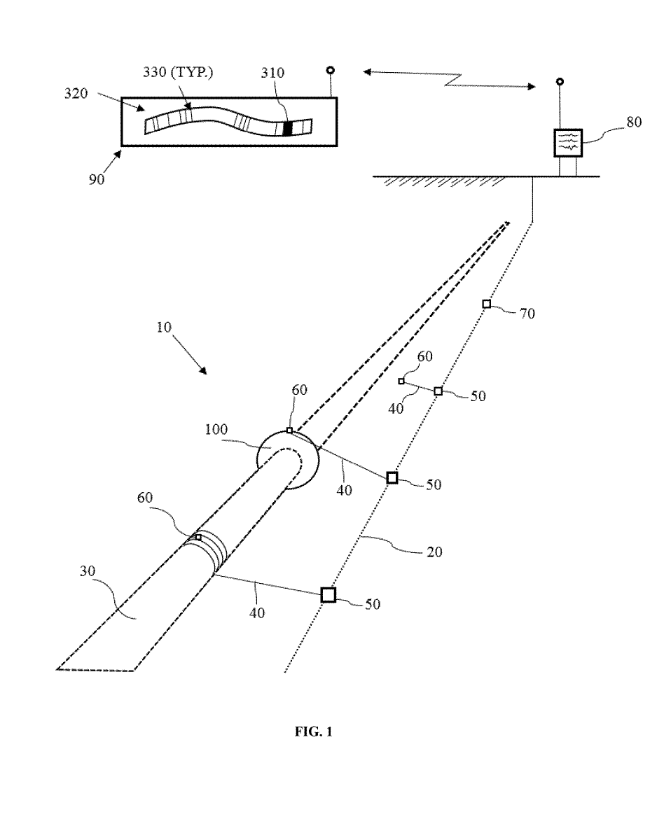

FIG. 1 shows a schematic diagram of an embodiment of the present disclosure. A monitoring system 10 includes a backbone cable 20 extending along the length of a buried structure, shown in this embodiment as a pipeline 30 to be monitored. For simplicity, the ground is not shown. A branch cable 40 extends between a branch cable junction 50 and a sensing device 60 (e.g. a point sensor or other sensor). The branch cable 40 may itself provide the functionality of the sensing device 60, such as a fibre optic cable (and thus do not require a discrete or separate sensing device 60). A number of unused branch cable junctions 70 may be provided along the backbone cable 20 to provide for future expansion/addition. One or more flow barriers 100 may be used to reduce or eliminate the spread or flow of leaked liquids along the length of the buried structure (pipeline 30 shown).

For simplicity, as used herein, the buried structure to be monitored is referred to as “a pipeline” but the buried structure may include conduits, waste containment systems, sewers, storage tanks, or other underground structures where disturbance or leak monitoring is required. The buried structure to be monitored may also include buried cable systems for power transmission or communications or for civil drainage systems.

The monitoring system 10 may be installed for a pipeline 30 carrying unrefined hydrocarbons, refined products, gas, water or other products. In an embodiment disclosed, one or more monitoring systems may be installed in a right-of-way or utility corridor where a plurality of pipelines 30 or other buried structures have been placed in close proximity, allowing each system to monitor one or more of the buried structures (i.e. one monitoring system 10 may be used to monitor for leaks from a plurality of buried structures in close proximity).

In an embodiment disclosed, the monitoring system 10 may be used to monitor for disturbances such as: leaks of liquids or gases; incursions by unauthorized personnel that may damage the buried structure; theft of equipment, materials or products; and ground movement that could damage the buried structure, or combinations thereof.

The backbone cable 20 may itself be a sensing device 60 such as a fibre optic cable, using techniques such as distributed acoustic sensing to detect a leak or ground incursion. In an embodiment disclosed, the backbone cable 20 is a single cable or an assembly of one or more types of cables or wires or filaments that are capable of transmitting data, signals by various means, electrical power, or a combination thereof to power sensing devices 60 or other devices. The backbone cable 20 may have one or more branch cable junctions 50 where branch cables 40 or sensing devices 60 can be connected and data, signals, power or combinations thereof are transmitted to and from the sensing devices 60.

The sensing devices 60 may include, for example: fibre optic systems that provide distributed temperature or distributed acoustic sensing (or a combination thereof); reactive polymer sensors; vapour sensing tubes; hydrocarbon sensing cables; optical sensors; or combinations thereof. Each sensing device 60 is generally configured to detect a specific range of products. For example, fibre optic systems can detect a range of products since they react to how the product changes the environment around the pipeline 30 rather than to the product itself. Distributed acoustic systems using fibre optic cables are also able to detect intrusions whereas the other sensor devices described generally focus on detecting leaks. One or more types of sensing devices 60 may be selected to detect the type of disturbance to be monitored/surveilled.

The sensing devices 60 and the backbone 20 work with known electronics systems 80 to operate the sensing device 60 and to receive/interpret the results. Power for the sensing devices 60 may be supplied from the electronics systems 80 through the backbone 20 or by a separate cable system or solar powered with battery back-up if required.

In an embodiment disclosed, the signal or indication from the sensing device 60 is received at a monitoring station 90, for example via telecommunication network or otherwise, where an indication, recordation, alarm or other notification 310 is provided to an operator or pipeline control system to take a disturbance response action (e.g. a leak response action). The monitoring station 90 may also provide a representation 320, 330 of the pipeline 30 and the flow barriers 100. The leak response action may include ceasing operation of the buried structure (e.g. pipeline 30), reducing pressure, reducing flowrate, closing emergency shutdown valves, initiating a leak response plan or combinations thereof. The leak response action may be automatic, e.g. by the pipeline control system.

The backbone cable 20 may be installed above, below or beside the buried structure (e.g. pipeline 30), or may be attached to the pipeline 30, in close proximity to the pipeline 30 (e.g. less than 1 m) or at some distance (e.g. several metres) from the buried structure (e.g. pipeline 30) depending on the application.

For new pipelines 30 the backbone cable 20 can be placed anywhere that is convenient, preferably during the construction phase so that the backbone cable 20 could be placed in a trench with the pipeline 30 before the trench is padded and backfilled. For existing pipelines 30, one could excavate to access the pipeline 30, but it may be more practical to install the backbone cable 20 in a separate trench or conduit a safe distance from the pipeline 30 to reduce the chance of damaging the pipeline 30 by excavation during installation of the backbone cable 20.

The branch cable junctions 50 may be built into the backbone cable 20 when the backbone cable 20 is manufactured, installed on the backbone cable 20 during installation, installed on the backbone cable 20 after the backbone cable 20 is installed in the ground or combinations thereof. The branch cable junctions 50 may include a direct connection between the branch cable 40 and the backbone cable 20 or may include a junction connector (e.g. tee-connector) or a junction box or combinations thereof.

In an embodiment disclosed, the branch cable junctions 50 are installed at intervals along the backbone cable 20. In an embodiment disclosed, the intervals may be regular intervals or variable intervals or combinations thereof. The interval between successive branch cable junctions 50 may be less than 1 m along the backbone cable 20 to accommodate areas where multiple sensing devices 60 are required. In other cases, branch cable junctions 50 may be placed several kilometres apart if the operator deems that no sensing devices 60 are required over a particular segment of the pipeline 30.

In an embodiment disclosed, the branch cable junctions 50 may be installed at selected critical locations along the backbone cable 20 such as in locations where a leak would cause greater consequences, such as at or near a river crossing.

In an embodiment disclosed, the unused branch cable junctions 70 may have enclosures or coverings that protect the unused branch cable junction 70 from damage when installed in the ground but can be accessed or removed after the backbone cable 20 is installed in the ground to allow the branch cables 40 or sensing devices 60 to be added to unused branch cable junctions 70 as the need arises. The enclosures or coverings may be plastic or metallic or any other material suitable for long burial in soil and wet conditions while providing a seal to prevent degradation of the unused branch cable junctions 70 and backbone cable 20.

In an embodiment disclosed, the branch cable junctions 50 may be configured so that the branch cables 40 can be easily replaced or removed without affecting the integrity of the backbone cable 20 if the sensing device 60 or branch cable 40 or both are damaged, require repair/replacement, become obsolete or are no longer needed. The branch cable junction 50 (and unused branch cable junction 70) and connected devices (e.g. branch cables 40 or sensing device 60 or both) may incorporate proven or novel “wet connect” plug-and-socket type connectors as are used in oilfield and other extreme operating environments.

The branch cable 40 may be a sensing device 60 such as, but not limited to, a fibre optic cable using distributed acoustic sensing to monitor for unwanted incursions on the pipeline right of way or using distributed strain sensing to monitor for ground movement around the pipeline 30. In an embodiment disclosed, the branch cable 40 connects one or more sensing devices 60, that monitor one or more pipelines 30, to the backbone cable 20.

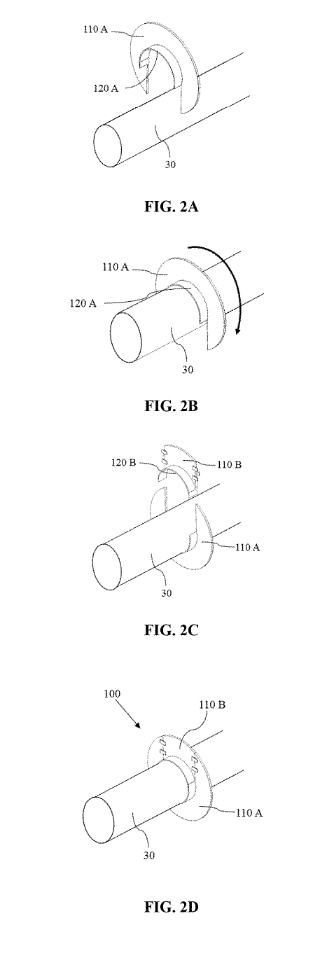

Referring generally to FIGS. 2A-10B, exemplary configurations for the flow barrier 100 are shown. The flow barrier 100 includes a relatively low permeability (or impermeable) material around and below the pipeline 30 designed and constructed to restrict or prohibit the flow of leaked fluids along the pipeline 30 to facilitate pooling and/or to direct leaked liquids to a sensing device 60. While the flow barrier 100 is shown with a substantially circular configuration, the outer edge profile of the flow barrier 100 may be any regular shape (such as circular or rectangular) or may be any irregular or custom shape as required to conform to the shape of the buried structure and/or the excavation in which the buried structure is situated.

The flow barrier 100 may be constructed of metal, plastic or other rigid or semi-rigid material. In an embodiment disclosed, the flow barrier 100 is sized to extend substantially to the edge of the excavation (e.g. trench) around the pipeline 30 to impair flow through any soil disturbed around the pipeline 30 during initial construction or any subsequent excavations to inspect, repair or otherwise expose the pipeline. Smaller flow barriers 100 can be used but these will be less effective at impairing flow than a larger flow barrier 100.

In an embodiment disclosed, the flow barriers 100 may be installed at any location along the pipeline 30 and at any interval depending on the requirements of the pipeline owner/operator. The owner/operators may choose to preferentially install flow barriers 100 (and associated sensing device 60) at locations where the probability of a leak occurrence may be higher such as in potentially unstable slope regions or over segments with unfavourable soil conditions. In areas where the consequences of leaks may be higher, such as at water crossings, and these consequences can be reduced by preventing flow along the pipeline 30, multiple flow barriers 100 may be installed (e.g. in tandem or multiple barriers) adjacent to or in close proximity of each other to provide redundancy. In other cases, the flow barriers 100 may be installed at intervals of several kilometres apart.

The flow barrier 100 may be made from a single element or may be made from a plurality of elements that overlap, interlock or are otherwise joined to form the flow barrier 100.

Referring to FIGS. 2A-2D, the flow barrier 100 may be deployed as separate elements 110A and 110B. As illustrated, element 110A may be generally U-shaped and be positioned on the pipeline 30, rotated, and mating element 110B inserted and the elements 110A and 110B joined. The separate elements 110A and 110B are connectable and held together by one or more fasteners. A flange 120A, 120B is provided to support the flow barrier 100 on the pipeline 30.

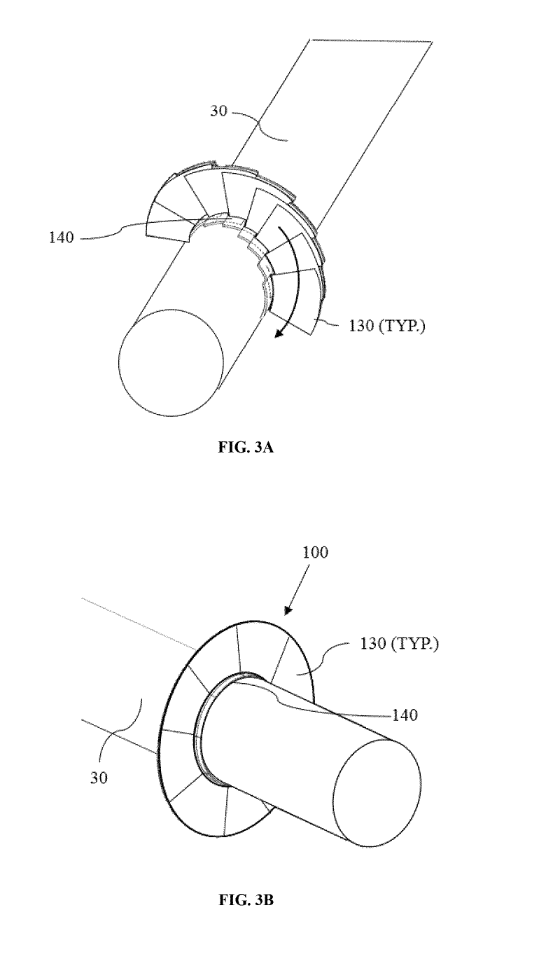

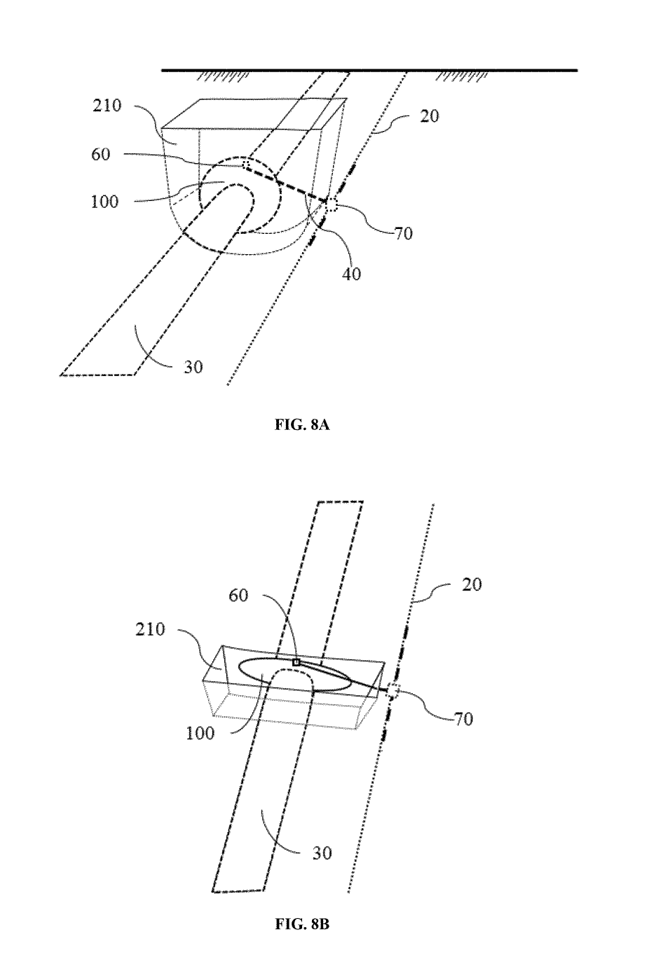

Referring to FIGS. 3A-3B, the flow barrier 100 may be deployed as an assembly of elements 130. The elements 130 may be affixed to the pipeline 30 by a flange 140 to form a circumference. The elements 130 may overlap (FIG. 3A) or abut (FIG. 3B) to form a substantially fluid impermeable flow barrier 100. The flow barrier 100 may be deployed into the excavation (210 in FIGS. 8A-8B) with the individual elements 130 overlapping, then the elements 130 can be fanned out around the pipeline 30 to form the flow barrier 100.

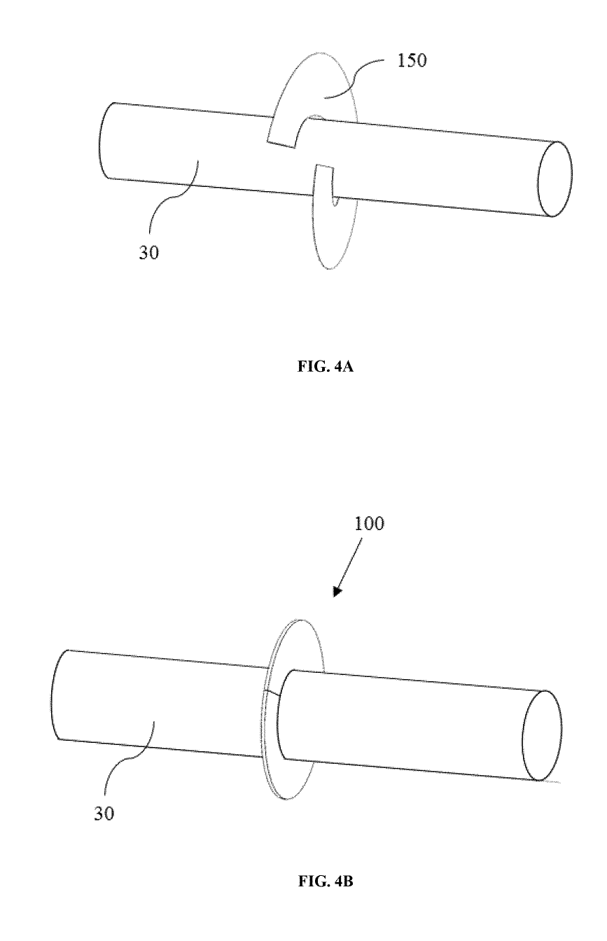

Referring to FIGS. 4A-4B, the flow barrier 100 may be deployed as a flexible single element 150 constructed of materials such as metal or plastic that can be temporarily bent, twisted or otherwise manipulated to allow it to be installed over the pipeline 30 but then will substantially recoil to a shape that conforms to the pipeline 30 to form a rigid or semi-rigid flow barrier 100.

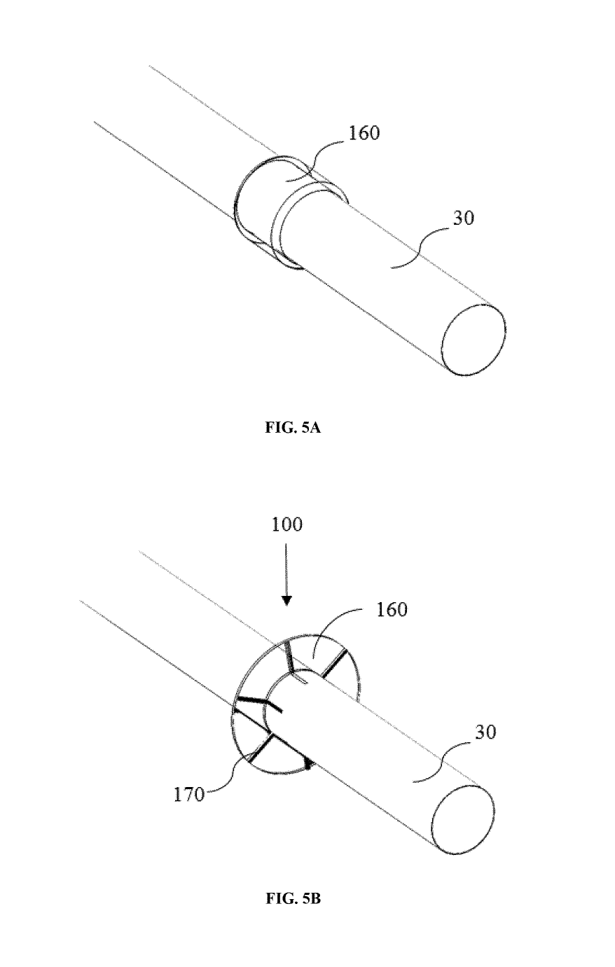

Referring to FIGS. 5A-5B, the flow barrier 100 may be deployed as a compliant, flexible element, fluid impermeable membrane 160, such as a rubber sheet (such as neoprene, butyl or silicone), plastic sheet (such as polyethylene, nylon or pvc), or textiles (such as a geotextile impregnated with asphalt, elastomer or polymer). One or more stiffening members 170 are provided to add stiffness or strength (such as supplementary rods, bars, tubes or integral structures such as ridges, pleats, folds or crimps in the material itself) to support the impermeable membrane 160. Stiffening members 170 may also be used with other configurations of the flow barrier 100.

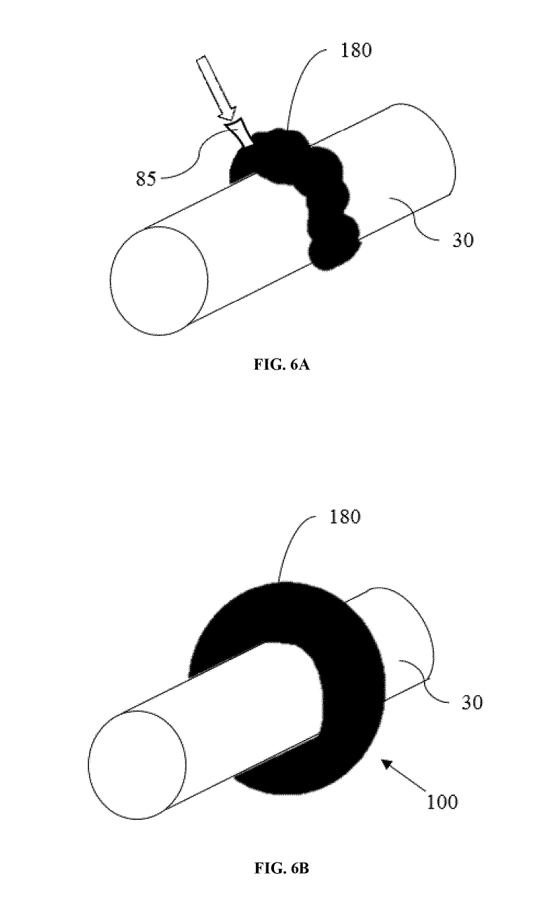

Referring to FIGS. 6A-6B, the flow barrier 100 may be deployed as a structure 180 having tubes or pockets that can be inflated or filled through a material injection port 185 with material such as expanding foam, slurry or cement to increase the size and rigidity of the structure (and thus the flow barrier) and to expand the structure 180 to conform to the pipeline 30 and/or the surrounding soil, like a tube or tire. In an exemplary embodiment, the structure 180 is installed on or around the pipeline 30 and subsequently expanded by injecting cement through port 185 to provide the flow barrier 100. The structure 180 may form a generally cylindrical or generally toroidal shape, or other shape as may be preferential.

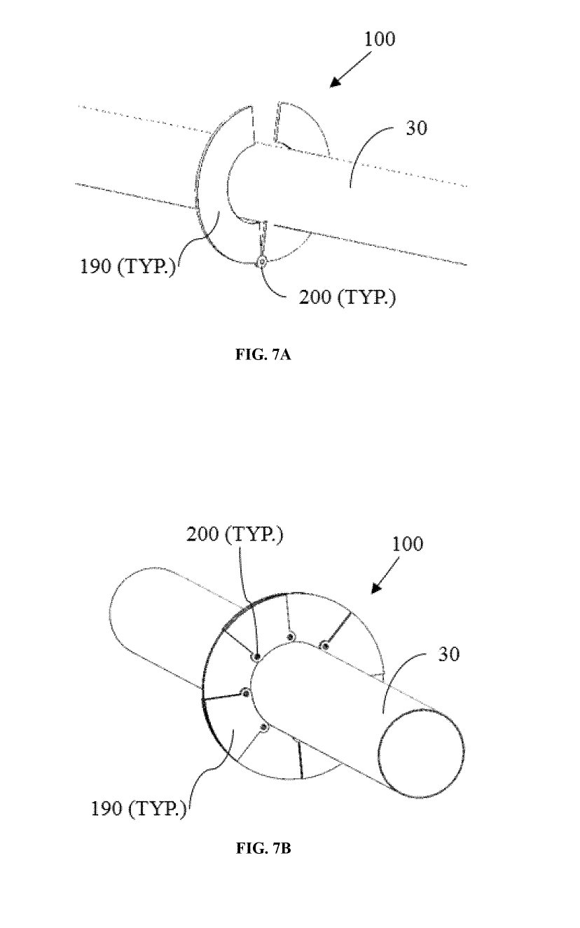

Referring to FIGS. 7A-7B, the flow barrier 100 may be deployed as a plurality of hinged components 190 connected by pins 200 to facilitate installation on the pipeline 30. The number of hinged components 190 must be at least two (FIG. 7A), but may be several (seven shown in FIG. 7B).

Referring to FIGS. 8A-8B, in an embodiment disclosed, the flow barrier 100 may be deployed in an excavation 210 (for example a narrow trench) around an existing pipeline 30, for example exposed by a flow of pressurized water and vacuum (e.g. hydrovac excavation or daylighting etc.) to reduce the risk of damage to the pipeline 30. The flow barrier 100 may then be installed, and if applicable one or more sensing devices 60 deployed and connected with the backbone cable 20 at an unused branch cable junction 70, and the excavation 210 subsequently carefully padded and backfilled.

The flow barrier 100 may be attached to the buried structure (e.g. pipeline 30), and may be attached using mechanical devices or fasteners such as one or more clamps, straps or fasteners or may be attached using adhesive products or combinations thereof. In an embodiment disclosed, the flow barriers 100 may be pre-installed on segments of the pipeline 30 prior to installation of the pipeline 30.

The flow barrier 100 may be placed in close proximity to the pipeline 30 without being affixed to the pipeline 30, although it is preferable to reduce any gap between the pipeline 30 and the flow barrier 100 as much as possible to prevent or reduce liquid flow between the flow barrier 100 and the pipeline 30. The gap, if any, between the pipeline 30 and the flow barrier 100 may be sealed with a sealing device or a sealant.

The flow barrier 100 may have a shaped outer edge profile, such as a regular shape (such as circular or rectangular), may be designed to fit the general shape of an excavation (e.g. trench, hole or pit), or can be customized, prior to or during installation to conform to the shape required for a specific application such as where the flow barrier 100 must conform to an obstruction near the pipeline 30 such as a boulder or an adjacent pipeline.

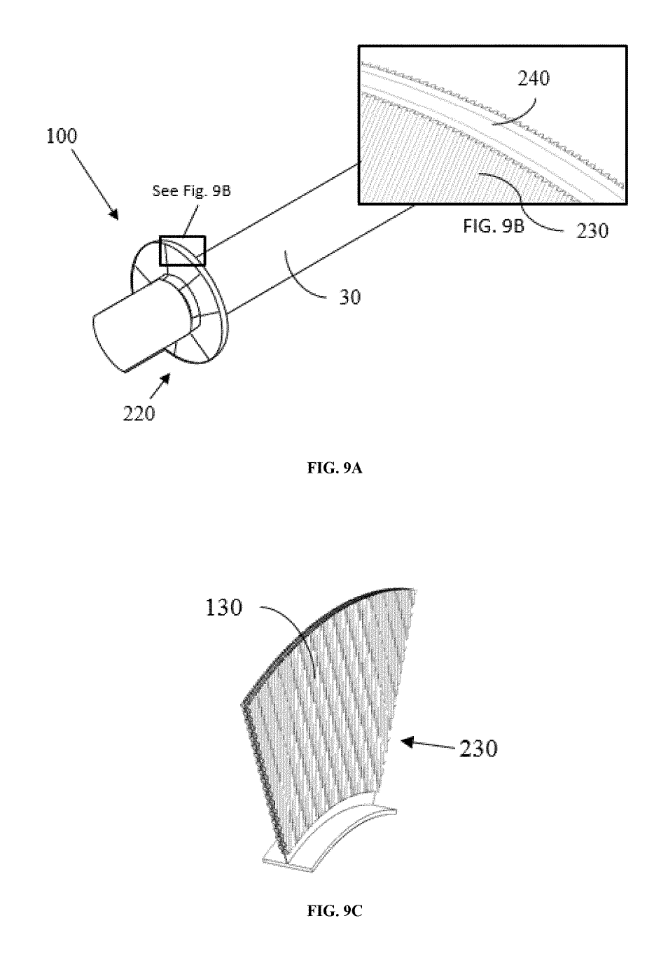

Referring to FIGS. 9A-9D, the flow barrier 100 may incorporate surface structures 220 such as tubes, channels or preferential flow paths oriented linearly (in one direction such as vertical or horizontal or diagonally), radially (such as from the centre of the pipeline 30), circumferentially (as either one or more spiral or concentric rings) or other arrangement to direct fluids to a sensing device 60. Referring to FIG. 9B, channels 230 are shown generally radial and channels 240 are shown generally circumferential. The flow barrier 100 may direct the fluids to the sensing device 60 by guiding the fluid or by conveying the fluid by any known physical or chemical means including, for example, selective capillary action, selective permeation, density-based displacement, or a combination thereof.

The flow barrier 100 may incorporate materials such as geosynthetic drain fabric to direct fluids to a sensing device 60 and/or incorporate coatings or materials (such as engineered polymers which may or may not incorporate materials such as nano carbon or metal particles) that respond to contact with selected fluids such as hydrocarbons such that all, or a portion of the surface of the flow barrier 100 functions as a sensing device 60.

The flow barrier 100 may have troughs, grooves or other such surface finish machined or etched or rolled into the surface, material with the desired surface finish may be attached to the surface, a permeable material that tends to wick oil-based products by capillary action may be attached to the surface of the barrier, or small diameter capillary tubes may be affixed to the surface, or combinations thereof.

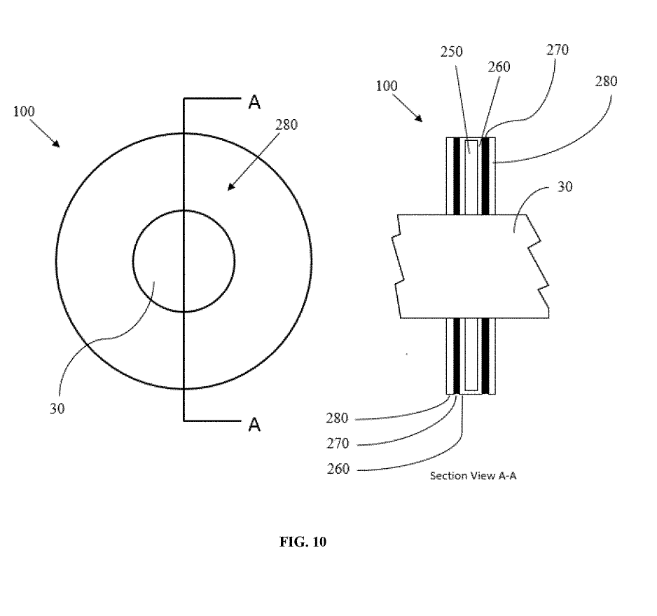

Referring to FIG. 10, the flow barrier 100 may be deployed as a composite structure with various elements or layers providing different functions. For example, a rigid core or base structure 250 of metal provides structural integrity, and one or more layers of plastic material 260 (e.g. polymer coating) provide corrosion protection for the rigid base structure 250. One or more layers of corrugated structures 270 (e.g. geotextile) provide flow conduits and one or more exterior layers of fines filter 280 (e.g. geotextile) excludes fine soil particles from clogging the flow conduits of the corrugated structure 270.

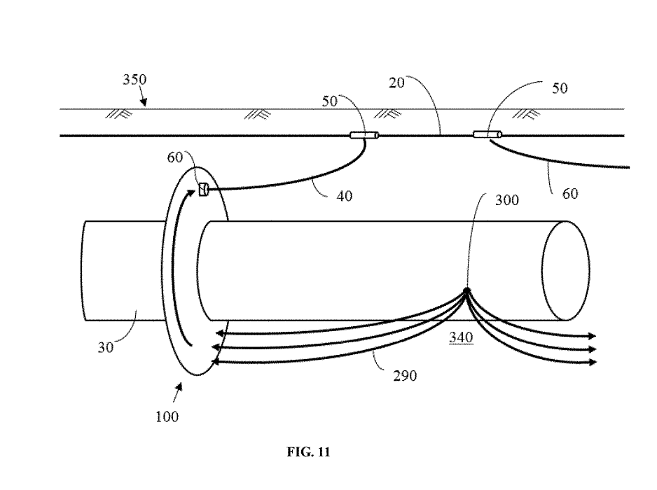

Referring to FIG. 11, if leaked liquid 290 escapes from the pipeline 30 by a leak 300 (for example a hole or crack), the liquid 290 flows along the pipeline 30 in the disturbed soil 340 in the backfilled trench until it encounters the flow barrier 100. The liquid 290 is then directed towards sensing device 60 on the flow barrier 100. Sensing device 60 is connected by branch cable 40 to branch cable junction 50 on the backbone cable 20. Also depicted in FIG. 11 is a sensing device 60 proximate to the ground surface 350 and connected to the backbone cable 20, for example to detect a ground incursion.

In an embodiment disclosed, the flow barrier 100 restricts or reduces migration of the leaked liquid along the buried structure (e.g. pipeline 30). Even a small or slow leak which cannot migrate away, is more readily detected by the sensing devices 60, as a small leak or slow leak may tend to pool or collect at or near the flow barrier 100 or sensing device 60 or both, which may increase the signal to provide notice of the leak to the monitoring station 90. In an embodiment disclosed, the flow barrier 100 serves to form a collection point to direct the leaked fluid towards at least one of the sensing devices 60. In an embodiment disclosed, at least one of the sensing devices 60 is located between, within, or near the one or more flow barriers 100.

In operation, upon a disturbance of the buried structure (e.g. a ground incursion or a leak, the sensing device 60 will detect the liquid 290 and/or the ground incursion and the signal is conveyed along the backbone cable 20 to the electronics system 80 and transmitted to the monitoring station 90 to alert an operator to shut down the pipeline 30 or take an appropriate leak response action. If the event is a leak, the flow barriers 100 would restrict the flow of the liquid 290 along the pipeline 30 and the liquid 290 would then be directed to sensing device 60.

In the preceding description, for purposes of explanation, numerous details are set forth in order to provide a thorough understanding of the embodiments. However, it will be apparent to one skilled in the art that these specific details are not required. In other instances, well-known structures are shown in block diagram form in order not to obscure the understanding.

The above-described embodiments are intended to be examples only. Alterations, modifications and variations can be effected to the particular embodiments by those of skill in the art. The scope of the claims should not be limited by the particular embodiments set forth herein, but should be construed in a manner consistent with the specification as a whole.

What is claimed is:

1. A method for detecting a disturbance of a buried structure, comprising:
placing a backbone cable proximate to the buried structure, the backbone cable having a plurality of branch cable junctions;
sensing the disturbance at one or more sensing devices, the sensing devices connected with branch cables to the backbone cable; and
indicating the disturbance to an operator or a control system to take a disturbance response action.

2. The method of claim 1, wherein the buried structure contains a fluid and the disturbance comprises a leak of a leaked fluid.

3. The method of claim 2, wherein the buried structure comprises at least a portion of a pipeline.

4. The method of claim 3, further comprising providing one or more flow barriers around an outer perimeter of the pipeline at discrete locations along the pipeline, wherein the flow barriers are adapted to restrict or prohibit flow or movement of the leaked fluid along the pipeline, direct the leaked fluid towards one or more sensing devices located within or near at least one of the one or more flow barriers, or combinations thereof.

5. A monitoring system for detecting a disturbance of a buried structure, comprising:
a backbone cable, adapted to extend along a length of the buried structure, the backbone cable having a plurality of branch cable junctions;
one or more sensing devices, placed along the backbone cable, and connected with the backbone cable via the branch cable junctions, at least one of the one or more sensing devices adapted to sense the disturbance; and
an output for indicating the disturbance.

6. The monitoring system of claim 5, wherein the one or more sensing devices are selected from the group consisting of fibre optics, reactive polymer sensors, vapour sensing tubes, hydrocarbon sensing tubes, optical sensors, and combinations thereof.

7. The monitoring system of claim 5, wherein the buried structure contains a fluid and the disturbance comprises a leak of a leaked fluid.

8. The monitoring system of claim 7, wherein the buried structure comprises at least a portion of a pipeline.

9. The monitoring system of claim 8, further comprising one or more flow barriers around an outer perimeter of the pipeline at discrete locations along the pipeline, wherein the flow barriers are adapted to restrict or prohibit flow or movement of the leaked fluid along the pipeline, direct the leaked fluid towards one or more sensing devices located within or near at least one of the one or more flow barriers, or combinations thereof.

10. The monitoring system of claim 9, wherein the at least one of the one or more sensing devices is located within or proximate to the at least one of the one or more flow barriers.

11. The monitoring system of claim 10, wherein the one or more flow barriers comprise a surface configuration adapted to direct the leaked fluid towards the at least one of the one or more sensing devices.

12. The monitoring system of claim 11, wherein the surface configuration is selected from the group consisting of a least one trough, at least one groove, a wick, at least one capillary tube, and combinations thereof.

13. An apparatus for restricting or directing the flow of a leaked fluid from a pipeline, comprising a flow barrier adapted to be placed around an outer perimeter of the pipeline.

14. The apparatus of claim 13, wherein the flow barrier is adapted to be placed in close proximity or affixed to the pipeline.

15. The apparatus of claim 13, wherein the flow barrier comprises a single element.

16. The apparatus of claim 13, wherein the flow barrier comprises a plurality of elements that overlap, interlock or are otherwise joined to form the flow barrier.

17. The apparatus of claim 13, wherein the flow barrier comprises a compliant, fluid impermeable membrane.

18. The apparatus of claim 13, wherein the flow barrier comprises one or more tubes or pockets, adapted to be inflated or filled with a filler material to conform the flow barrier to the pipeline or to surrounding soil or both.

19. The apparatus of claim 13, further comprising one or more sensing devices within or proximate to the flow barrier, at least one of the one or more sensing devices adapted to detect the leaked fluid.

20. The apparatus of claim 19, wherein the one or more sensing devices are selected from the group consisting of fibre optics, reactive polymer sensors, vapour sensing tubes, hydrocarbon sensing tubes, optical sensors, and combinations thereof.

21. The apparatus of claim 19, wherein the flow barrier comprises a surface configuration adapted to direct the leaked fluid towards at least one of the one or more sensing devices.

22. The apparatus of claim 21, wherein the surface configuration is selected from the group consisting of a least one trough, at least one groove, a wick, at least one capillary tube, and combinations thereof.
